(19) United States
(12) Patent Application Publication
(10) Pub. No.: US 2022/0362942 A1
(43) Pub. Date: Nov. 17, 2022

(54) METHOD FOR DETECTING SLIPPAGE WHEN GRIPPING AN OBJECT WITH A GRIPPER

(71) Applicant: Hochschule Karlsruhe, Technik und Wirtschaft, Karlsruhe (DE)

(72) Inventors: Klemens GINTNER, Ettlingen (DE); Bernhard BECK, Keltern (DE); Michael WEBER, Karlsruhe (DE)

(21) Appl. No.: 17/625,214

(22) PCT Filed: Jul. 7, 2020
(86) PCT No.: PCT/EP2020/069081

§ 371 Date: Jan. 6, 2022

(30) Foreign Application Priority Data
Sep. 7, 2019 (DE) 10 2019 210 090.2

(51) Int. Cl. B25J 13/08; B25J 9/16

(52) U.S. Cl. CPC B25J 13/083; B25J 9/1612

(57) ABSTRACT

The present invention relates to a method for detecting slippage when gripping an object with a gripper, in which use is made of at least one acceleration sensor (5) on a gripping surface (3) of the gripper (1), a sensor signal from the acceleration sensor (5) is captured during the gripping process and filtered in order to obtain a filtered sensor signal in a first frequency range, and the filtered sensor signal or a value derived therefrom is compared with a threshold value (SW₁, SW₂) which, when exceeded, constitutes an indication of slippage of the object. In the method, the acceleration sensor (5) is integrated into a rigid main body (2) and the main body (2) is integrated into the gripper (1) using an elastic material (4) so as to be capable of oscillation on the gripping surface (3) such that, in the event of slippage of the object, said main body can be set in oscillation on the gripper (1) only in a plane parallel to the gripping surface (3). The first frequency range is selected such that the oscillation frequencies of the main body (2) that occur in the event of slippage are within the first frequency range. The proposed method allows simple and reliable detection of slippage.

### TECHNICAL FIELD OF APPLICATION

The present invention relates to a method for detecting slippage when gripping an object with a gripper, in which at least one acceleration sensor is used on a gripping surface of the gripper, at least one sensor signal from the acceleration sensor is captured during a gripping process and filtered with one or more frequency filters in order to obtain a filtered sensor signal in a first frequency range, and the filtered sensor signal or a value derived therefrom is compared with a first threshold value which, when exceeded constitutes an indication of slipping of the object.

Nowadays, grippers are used in many areas to be able to grip objects and move them in a controlled manner. Examples are hand prostheses or robots in automation technology. Gripping the objects should be as reliable as possible and slipping of a gripped object should be detected in a timely manner.

### PRIOR ART

Various techniques in which slippage of the object can be detected with one or more sensors are known for monitoring the gripping of an object with a gripper. Examples of such techniques comprise detecting a change in heat transfer at the gripping surface or measuring forces and/or oscillations at the gripping surface. For example, from N. R. Tremblay et al, “Utilizing Sensed Incipient Slip Signals for Grasp Force Control”, Symposium on Flexible Automation, 1992, San Francisco, pages 1 to 7, the use of an acceleration sensor arranged on the gripping surface of the gripper is known. In this case, the acceleration sensor is embedded in the tip of a foam cone covered by a textured artificial skin. The acceleration sensor is used to capture the vibrations that occur at the foam cone during slippage of a gripped object. The sensor signal from the acceleration sensor is then first amplified and filtered using a bandpass filter with a passband of 400 to 700 Hz. The filtered sensor signal is converted with an RMS-DC converter to detect slippage when an appropriate threshold is exceeded. However, the reliability of the detection of slippage with this sensor is still unsatisfactory. The same authors have therefore integrated a second acceleration sensor on one side of the fingertip in a refined development in order to increase the reliability of the detection (cf. M. R. Tremblay et al., “Estimating Friction Using Incipient Slip Sensing During a Manipulation Task”, Proc. 1993 IEEE Int. Conf. on Robotics & Automation, pages 429 to 434).

The object of the present invention is to provide a method for detecting slippage when gripping an object with a gripper, which enables reliable detection of slippage using an acceleration sensor.

### SUMMARY OF THE INVENTION

The object is achieved with the method according to patent claim 1. Advantageous configurations of the method are the subject matter of the dependent patent claims or can be taken from the following description and the exemplary embodiment.

In the proposed method for detecting slippage when gripping an object with a gripper, at least one acceleration sensor is used on a gripping surface of the gripper. At least one sensor signal provided by the acceleration sensor during a gripping process is captured and filtered with one or more frequency filters in order to obtain a filtered sensor signal in a first frequency range. The filtered sensor signal or a value derived therefrom is compared with a threshold value which, when exceeded, constitutes an indication of slippage of the object. Depending on the configuration of the method, slippage is already assumed to have occurred when the threshold value is exceeded, or only when further indications are present in addition to the threshold value being exceeded. The proposed method is characterized by the fact that the acceleration sensor is integrated into a rigid main body and the main body is integrated capable of oscillation into the gripper on the gripping surface of the gripper using an elastic material which supports the main body laterally in such a manner that in the event of slippage of the object, the main body can be set in oscillation on the gripper only in a plane parallel to the gripping surface, which oscillation can be detected with the acceleration sensor. The integration of the main body into the gripping surface or gripper is therefore carried out in such a manner that the main body can only be moved due to the elastic material relative to the gripper in a plane parallel to the gripping surface and can oscillate accordingly, but not in the direction perpendicular to this plane. The first frequency range is then selected in the proposed method such that the oscillation frequencies of oscillations of the main body (in the plane parallel to the gripping surface), which occur in the case of slippage of the object, lie within the first frequency range.

By integrating the acceleration sensor into a rigid main body and mounting this main body in such a manner that it can only perform oscillations parallel to the gripping surface, referred to below as the x- and y-directions, which can be captured by the acceleration sensor, a high level of reliability and detection sensitivity of slippage when gripping an object is achieved. Here, the method requires only one acceleration sensor and can be implemented at low cost. Depending on the application, this sensor can be configured to be sensitive in only one direction, for example in the x- or y-direction, or in both directions as a 2D acceleration sensor. A 3D acceleration sensor can also be used, of which only the two accelerations captured parallel to the gripping surface are then essential for determining the slippage. The main body can also have two one-dimensional acceleration sensors, one of which is sensitive in the x-direction and the other one in the y-direction. Several of the main bodies described with integrated acceleration sensors can also be integrated in a correspondingly extended gripping surface. In the case of gripping surfaces that are not planar over the entire area, the plane parallel to the gripping surface is to be understood as parallelism to a local area or a tangential surface at this local area where the main body is integrated. Here, the main body is integrated into the gripping surface or gripper in such a manner that it is supported laterally by an elastic material being inserted between the main body and the material of the gripper but is directly or rigidly coupled to the gripper in a direction perpendicular to the plane of the gripping surface, hereinafter referred to as the z-direction. In this manner, the elastic material allows the main body to oscillate only parallel to the plane of the gripping surface. These oscillations are captured by the acceleration sensor and the sensor signal of the acceleration sensor is evaluated after filtering to detect slippage. For this purpose, the sensor signal is first filtered with one or more frequency filters to obtain a filtered sensor signal in a first frequency range. This first frequency range is selected such that the oscillation frequencies of oscillations of the main body occurring during slippage lie within this frequency range. Frequencies that are too low or too high, which may be caused by the movement of the gripper itself or by high-frequency interference, are filtered out in the process. The filtering is preferably performed with a bandpass filter, the passband of which corresponds to the first frequency range. Preferably, a frequency of ≥50 Hz is selected as the lower limit of this first frequency range. Preferably, a frequency of ≤400 Hz is selected as the upper limit. The frequencies that occur during slippage depend, among other things, on the mass of the main body. The first frequency range is therefore preferably selected such that the resonant frequency of the main body oscillating on the gripper parallel to the gripping surface lies within this first frequency range. To suppress interference, this frequency range is preferably set to a width of S 200 Hz. Instead of a bandpass filter, a combination of several filters, for example a high-pass and a low-pass filter, can of course also be used.

In the proposed method, the filtered sensor signal is evaluated to detect slippage of an object. For this purpose, the sensor signal or a value derived therefrom, for example a moving average value of the signal amplitude (after rectification), is compared with a predetermined threshold value which, when exceeded, constitutes an indication of slippage of a gripped object. This threshold value can be determined by previous measurements or can be specified as an empirical value, hereinafter also referred to as the first threshold value. In a possible configuration, this threshold value can also be determined from a portion of the sensor signal of the acceleration sensor that lies in a frequency range above the first frequency range, hereinafter also referred to as the second threshold value. For example, after appropriate rectification, a moving average value of the signal amplitude can be calculated from this portion of the sensor signal that lies above the first frequency range, and twice this average value can be selected as the second threshold value.

Depending on the acceleration sensor used, the sensor provides only one sensor signal if an acceleration sensor is used that measures one-dimensionally or, for example, two sensor signals for two axes (x- and y-axis) running perpendicular to one another if a two-dimensional acceleration sensor is used. In the latter case, the two signals can then each be evaluated separately according to the proposed methods or—as will be explained further below—can be offset against each other to obtain a single sensor signal and can be evaluated according to the proposed method.

In the proposed method, it is then possible to draw the conclusion that a slippage of the gripped object occurred either already on the basis of this comparison with the threshold value, or only in connection with one or more further criteria. Thus, in a preferred configuration, in addition to the acceleration sensor, at least one force sensor is integrated into the gripper with which the gripping of an object with the gripper can be captured via a normal force on the gripping surface. Preferably, this force sensor is used below the main body, thus at the rigid coupling point between the main body and the gripper. The normal force (in the z-direction) that occurs when an object is gripped is then transmitted by the main body to the force sensor. In this configuration, slippage of an object is only assumed if the filtered sensor signal or the value derived therefrom exceeds the first and/or second threshold value and, at the same time, the sensor signal of the force sensor exceeds a threshold value for the normal force that indicates gripping of an object. The inclusion of the sensor signal from the force sensor represents a plausibility check since slippage of an object can only occur if an object has actually been gripped.

The proposed method enables a reliable evaluation of the gripping process, in particular, a slippage of a gripped object can be reliably detected. This is important for applications of, e.g., hand prostheses or also in applications in the field of automated processes, for example in production. It can be detected in real time whether the object is gripped firmly or whether the object is released from the grip and thus slips, thus slippage occurs. In this case, the gripper can then be caused to grip more firmly by a suitable control signal.

### BRIEF DESCRIPTION OF THE DRAWINGS

In the following, the proposed method is explained again in more detail by means of exemplary embodiments in connection with the drawings. In the figures

FIG. 1 shows an example of the configuration and integration of a main body with integrated acceleration sensor on the gripping surface of a gripper;

FIG. 2 shows a result of a measurement example during slipping, wherein
a) corresponds to the sensor signal of the acceleration sensor,
b) corresponds to the amplitude response of the sensor signal as a function of frequency,
c) corresponds to the sensor signal filtered with a bandpass filter,
d) corresponds to the amplitude response of the filtered sensor signal, and
e) corresponds to the moving average value determined from the filtered sensor signal compared with a predetermined threshold value;

FIG. 3 shows an example of the application of a threshold value determined from the upper frequency range in the measurement example of FIG. 2; and

FIG. 4 shows a flow chart for an exemplary configuration of the proposed method.

### WAYS TO CARRY OUT THE INVENTION

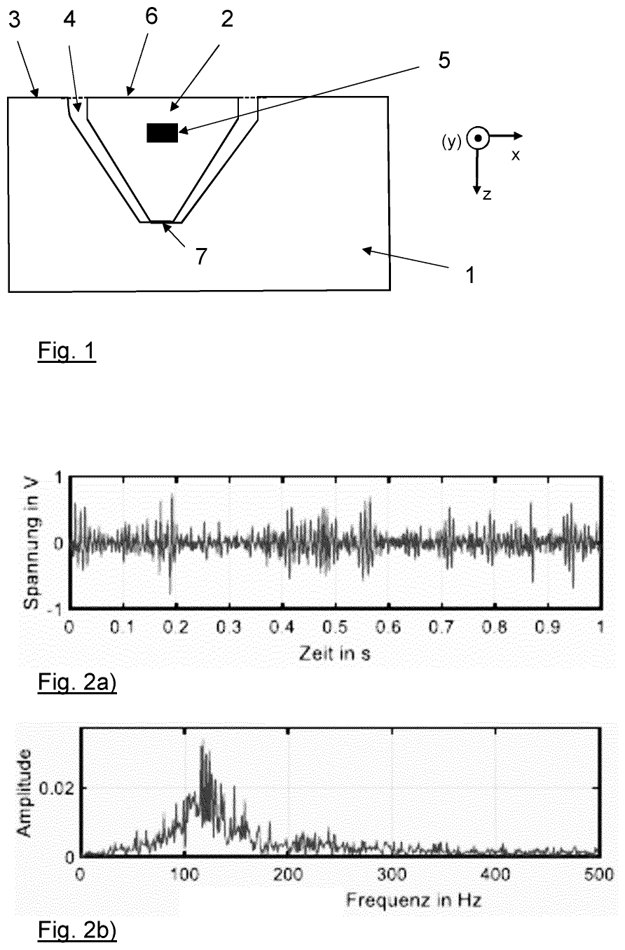

In the proposed method, a rigid main body with an acceleration sensor arranged therein is integrated into the gripper at the gripping surface in such a manner that the main body can only perform oscillations relative to the gripper that are parallel to the plane of the gripping surface. FIG. 1 shows an example of the integration of the main body 2 into the gripper 1, which is only partially shown in this example. The upper side of the main body 2 lies in the plane of the gripping surface 3 of the gripper 1. An elastic mass 4 is arranged between the main body 2 and the material of the gripper 1 and supports the main body 2 laterally and allows oscillation of the main body 2 relative to the gripper 1 in a plane parallel to the gripping surface 3. This elastic mass 4, for example made of silicone rubber, can enclose the main body 2 laterally in a form-fitting manner—as shown in FIG. 1—or only support it in the upper region. On the underside of the main body 2, the main body rests directly against the gripper 1, so that no oscillation of the main body 2 relative to the gripper 1 is possible in this direction (z-direction in FIG. 1). An acceleration sensor 5 with which oscillations of the main body 2 parallel to the gripping surface 3 can be captured is integrated into the main body 2.

When an object is gripped by this gripper 1, a normal force F_{N} acts in the z-direction on the main body 2, the upper side or contact surface 6 of which can either come into direct contact with the object or can also be covered by a protective layer.

In a preferred configuration of the proposed method, a force sensor 7 is additionally arranged on the underside of the main body 2 between the main body 2 and the gripper 1, as indicated only schematically in FIG. 1. This optional force sensor 7 then captures the forces occurring in the z-direction during gripping. Such a force sensor can of course also be integrated elsewhere in the gripper 1. Due to the conical configuration of the main body 2 in this example, increased pressure is exerted on the force sensor 7 during a gripping process with respect to the contact surface 6 of the main body 2, so that the force sensor 7 responds very sensitively to corresponding gripping forces. The force sensor 7 can be used to determine whether an object is being gripped. If the grip is insufficient, slippage of the object may occur, causing tangential forces F_{T,x} or F_{T,y} to act on the main body 2 in the x- or y-direction. In this case, the main body 2 is set into corresponding oscillations in x- and/or y-direction relative to the gripper 1, which oscillations are captured by the 2D acceleration sensor 5 for x- and y-direction in this example. It can be seen from FIG. 2 that slippage in this example leads to an oscillation (acceleration) in the range of approx. 120 Hz, wherein this can be detected by the acceleration sensor 5 due to the increased amplitude.

FIG. 2 shows the result of an exemplary measurement during slippage of a gripped object. Partial figure a) shows the sensor signal of the acceleration sensor for the oscillation in x-direction as a function of time. Partial figure b) shows the amplitude response of this sensor signal as a function of frequency. In the proposed method, this sensor signal is filtered to obtain only signal portions in a specific frequency range, in the present example between 50 and 200 Hz, in which the oscillations of the main body 2 in the gripper 1 caused by slippage occur. Partial figure c) shows a sensor signal filtered in such a manner with a bandpass filter. Partial figure d) shows the amplitude response of this filtered sensor signal as a function of frequency.

In the proposed method, a threshold value is now specified or determined with which the filtered sensor signal or a value derived from is compared. This threshold value SW₁ can be derived from empirical values or determined by preliminary measurements. In an advantageous configuration still to be described below, the threshold value, then referred to as SW₂, is determined from the sensor signal itself.

Depending on the configuration of the acceleration sensor, the sensor provides a sensor signal aₓ for a direction (for example x-direction) or—in the case of a two-dimensional acceleration sensor—two separate sensor signals aₓ, a_{y} for x- and y-direction. These sensor signals can then either be evaluated separately and in each case compared with the threshold value or further processed to obtain a signal corresponding to the magnitude of the acceleration |a|=(aₓ²+a_{y}²)^{0.5} and then to compare it with the threshold value.

In the present example, in partial figure e), a moving average value of the filtered sensor signal formed after rectification is compared with the predetermined threshold SW₁. If the moving average value exceeds this threshold value, slippage is detected.

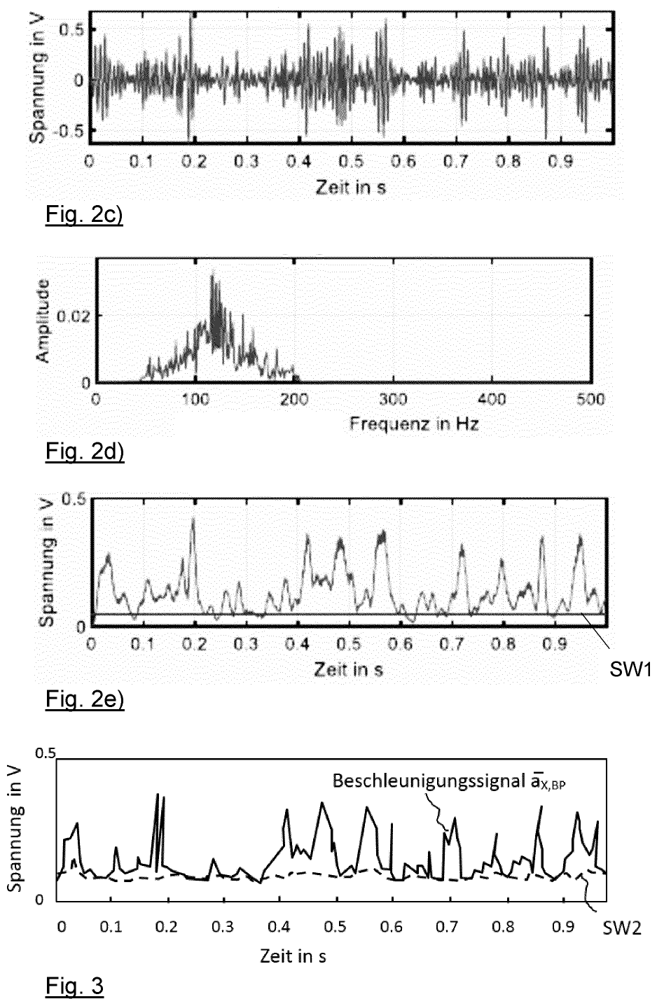

In an advantageous configuration, the threshold value can also be taken from the sensor signal outside the frequency range specified for the detection of slippage. For this purpose, in the example of FIG. 3, a portion of the sensor signal above the frequency range used for detecting slippage (50 to 200 Hz) is filtered out with a high-pass filter and a moving average value of this filtered sensor signal is calculated. In the present example, double of this moving average value is then used as the threshold value SW₂ and compared with the moving average value of the sensor signal filtered in the frequency range from 50 to 200 Hz. In the measurement of FIG. 3, the moving average value of the sensor signal filtered to detect slippage and the corresponding curve of the threshold value SW₂ can be seen. Here, too, slippage is assumed to have occurred when the threshold value SW₂ is exceeded. A combination of this temporally varying threshold value SW₂ with a fixed threshold value SW₁ as in FIG. 2 can also be used, in which case both threshold values must be exceeded in order to detect slippage. This use of two threshold values can be used for plausibility checks and further improvement of reliability.

A further increase in reliability can be achieved by additionally measuring the normal force F_{N} acting on the gripping surface 3 or the main body 2 with a force sensor. For this purpose, a threshold value SW_{FN} is specified, above which the gripping of an object with the gripper 1 can be assumed due to the occurring forces. When the threshold is later exceeded by the signal received from the acceleration sensor, slippage is only assumed to occur if the threshold for the signal from the force sensor was exceeded at the same time. This again only serves to check the plausibility of the detection. Instead of using a force sensor, the normal force F_{N} can also be determined according to Newton (F_{N}=m·a_{z}) from the acceleration signal for a_{z} (acceleration in the z-direction) from a 3D acceleration sensor.

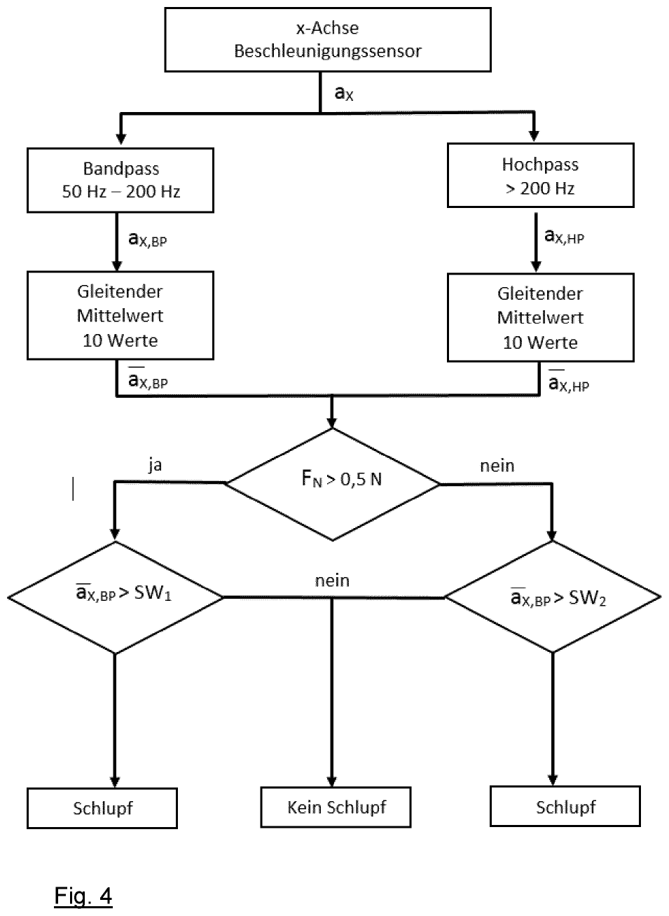

In a further configuration of the proposed method, the threshold values for the filtered sensor signal for detecting slippage can also be selected as a function of the holding force detected with the force sensor. When gripping larger objects and with the associated greater holding force, a fixed threshold value SW₁ can be selected. When gripping lighter and/or sensitive objects, the holding force is lower and the amplitude of the filtered acceleration signal is also correspondingly lower when slipping. In this case, the changing threshold value SW₂ is then preferably selected based on the moving average value of the portion of the sensor signal that contains only frequency portions above the frequency range selected for detecting slippage in order to be sure that no interferences are identified as slippage due to the smaller signal. For example, a normal force F_{N} of 0.5 N can be selected as the value for distinguishing between the two situations. If a holding force F_{N} of >0.5 N is detected with the force sensor, the fixed threshold value SW₁ described above is used. If a smaller holding force F_{N} is detected, the varying threshold value SW₂ is used. This procedure is illustrated again as an overview in a flow chart in FIG. 4.

The further processing, in particular filtering, and evaluation of the sensor signals can be carried out sufficiently quickly in the proposed method in a simple manner with the aid of a microcontroller.

If a three-dimensional acceleration sensor is used in the main body, the sensor signal can also be used additionally to evaluate the movement of the gripper, since the frequencies of the acceleration signal occurring in this case generally lie outside the range specific to sliding.

The signals captured in the proposed method can also additionally be used to determine the minimum mass of the object to be gripped, for example by means of the holding force and the direction of the acceleration due to gravity.

### REFERENCE LIST

1 gripper
2 main body
3 gripping surface
4 elastic mass
5 acceleration sensor
6 contact surface
7 force sensor

1. A method for detecting slippage when gripping an object with a gripper, in which
the gripper (1) is provided with at least one acceleration sensor (5) on a gripping surface (3) of the gripper (1), wherein the acceleration sensor (5) is integrated in a rigid main body (2) and the main body (2), with the aid of an elastic material (4) which supports the main body (2) laterally, is integrated in the gripper (1) so as to be capable of oscillation on the gripping surface (3) such that, in the event of slippage of the object, said main body can be set in oscillation on the gripper (1) only in a plane parallel to the gripping surface (3),
at least one sensor signal of the acceleration sensor (5) is captured during a gripping process and filtered with one or more frequency filters in order to obtain a filtered sensor signal in a first frequency range, and
the filtered sensor signal or a value derived therefrom is compared with a threshold value (SW1, SW2) which, when exceeded, constitutes an indication of slippage of the object,
wherein the first frequency range is selected such that oscillation frequencies of oscillations of the main body (2) which occur during slippage of the object, lie within the first frequency range.

2. The method according to claim 1,
characterized in
that filtering the sensor signal is carried out with a bandpass filter, the passband of which corresponds to the first frequency range.

3. The method according to claim 1,
characterized in
that a lower limit for the first frequency range is selected at ≥50 Hz.

4. The method according to claim 3,
characterized in
that the lower and an upper limits for the first frequency range are selected such that a resonant frequency of the main body (2) lies within the first frequency range.

5. The method according to claim 3,
characterized in
that the first frequency range is selected such that it has a width of ≤200 Hz.

6. The method according to claim 3,
characterized in
that an upper limit for the first frequency range is selected at ≤400 Hz.

7. The method according to claim 1,
characterized in
that the threshold value (SW2) is determined from a portion of the sensor signal of the acceleration sensor (5) which lies in a frequency range above the first frequency range.

8. The method according to claim 7,
characterized in
that from the portion of the sensor signal of the acceleration sensor (5) which lies in the frequency range above the first frequency range, a moving average value is calculated and at least twice this average value is selected as the threshold value (SW2).

9. The method according to claim 1,
characterized in
that a moving average value of the filtered sensor signal is compared with the threshold value (SW1, SW2).

10. The method according to claim 1,
characterized in,
that the gripper (1) is additionally provided with at least one force sensor (7) which is integrated in the gripper (1) and with which gripping of an object with the gripper (1) can be detected via a normal force on the gripping surface (3).

11. The method according to claim 10,
characterized in
that the force sensor (7) is mechanically coupled to the main body (2) in such a manner that the normal force is transmitted to the force sensor (7) via the main body (2).

12. The method according to claim 1,
characterized in
that the gripper (1) is provided with a three-dimensionally measuring acceleration sensor as an acceleration sensor (5) from the sensor signals of which a normal force acting on the gripping surface (3) is also calculated.

13. The method according to claim 10,
characterized in
that slippage is assumed only if both the threshold value (SW1, SW2) for the filtered signal of the acceleration sensor (5) is exceeded and the normal force measured with the force sensor (7) or calculated from sensor signals of the acceleration sensor (5) is above a predeterminable threshold value (SWFN) for the normal force.

14. The method according to claim 10,
characterized in
that in the case of a normal force which lies below a predeterminable value, a different threshold value (SW1, SW2) is used for the filtered signal of the acceleration sensor (5) than in the case of a normal force which lies above the predeterminable value.
